(19) United States
(12) Patent Application Publication
(10) Pub. No.: US 2025/0229740 A1
(43) Pub. Date: Jul. 17, 2025

(54) ATTACHMENT DEVICE

(71) Applicant: TOYODA GOSEI CO., LTD., Kiyosu-shi (JP)

(72) Inventors: Hirotake KONAKA, Aichi-ken (JP); Ryosuke JINNAI, Aichi-ken (JP)

(21) Appl. No.: 19/020,302

(22) Filed: Jan. 14, 2025

(30) Foreign Application Priority Data
Jan. 16, 2024 (JP) 2024-004593

(51) Int. Cl. B60R 21/213; B60R 21/232

(52) U.S. Cl. CPC B60R 21/213; B60R 21/232

(57) ABSTRACT

An attachment device for attaching, to a moving body, an airbag configured to be deployed downward in the moving body from a roof along a side wall of a vehicle interior, the attachment device includes: a first plate portion that is a plate-shaped member configured to be fixed to the vehicle interior of the moving body; and a second plate portion that is a plate-shaped member to which a tab of the airbag is fixed. The first plate portion and the second plate portion are arranged such that the first plate portion and the second plate portion face to different directions from each other. An attachment hole through which the tab of the airbag passes is formed in the attachment device. A part of the attachment hole is located in the first plate portion, and the other part of the attachment hole is located in the second plate portion.

### CROSS-REFERENCE TO RELATED APPLICATIONS

This application is based on and claims priority under 35 USC 119 from Japanese Patent Application No. 2024-004593 filed on Jan. 16, 2024, the entire content of which is incorporated herein by reference.

### TECHNICAL FIELD

The present disclosure relates to an attachment device.

### BACKGROUND ART

An airbag may be disposed on a side wall or a roof in a vehicle interior of a vehicle. The airbag is inflated by introducing a gas when the vehicle is subjected to an impact from the outside.

JP2005-104234A discloses an airbag device in which an airbag is attached to a bracket. The bracket fixes the airbag to a vehicle. The bracket extends downward from a roof side of the vehicle. The airbag, in a folded state, is fixed in a hole formed in a lower side of the bracket. When a side surface of the vehicle is subjected to an impact, a gas is introduced into the airbag. Then, the airbag is deployed downward in the vehicle.

### SUMMARY OF INVENTION

A door is disposed on a lateral side of the vehicle. By deploying the airbag downward from the roof on the lateral side of the vehicle, a head of an occupant may be protected from a broken glass of the door when the vehicle is subjected to the impact. When the gas is supplied to the airbag disposed on the roof of the vehicle, the airbag is easily deployed downward by gravity. Therefore, the airbag may be disposed in a vicinity of a lateral end portion of the roof of the vehicle. In the vicinity of the lateral end portion of the roof of the vehicle, a space for attaching an instrument in an upper-lower direction may not be sufficient. In the airbag device of JP2005-104234A, the bracket extends downward from the roof side of the vehicle. Further, the airbag is fixed to the lower side the bracket. Therefore, in JP2005-104234A, a region occupied by the airbag device is large in the upper-lower direction of the vehicle. Accordingly, depending on a lateral shape of the vehicle, there is a possibility that the airbag device in JP2005-104234A cannot be accommodated.

The present disclosure may be implemented by the following aspects.

(1) According to an aspect of the present disclosure, there is provided an attachment device for attaching, to a moving body, an airbag configured to be deployed downward in the moving body from a roof of the moving body along a side wall of a vehicle interior of the moving body, the attachment device including: a first plate portion that is a plate-shaped member configured to be fixed to the vehicle interior of the moving body; and a second plate portion that is a plate-shaped member to which a tab of the airbag is fixed, in which the first plate portion and the second plate portion are arranged such that the first plate portion and the second plate portion face to different directions from each other, and an attachment hole through which the tab of the airbag passes is formed in the attachment device, a part of the attachment hole being located in the first plate portion, and the other part of the attachment hole being located in the second plate portion.

According to the attachment device according to this aspect, a dimension in a direction along the first plate portion may be made smaller as compared with an aspect in which the first plate portion and the second plate portion are arranged to form a same plane. Therefore, the airbag may be attached to a space in a vicinity of a lateral end portion of the roof of the moving body.

(2) In the above attachment device, the first plate portion may include a fixing portion configured to fix the first plate portion to the vehicle interior of the moving body, a part of one end portion of the second plate may be connected to the first plate portion, the other part of the attachment hole may be located at a side of the one end portion with respect to an intermediate region in a direction from the one end portion toward the other end portion of the second plate portion, and the tab may be arranged from the attachment hole to the other end portion of the second plate portion.

Generally, when an impact is applied to the moving body, the airbag is inflated by being supplied with a gas. In an aspect in which the airbag is deployed downward from the roof of the moving body, the airbag is inflated downward from the roof of the moving body, so that a force is applied, by the airbag, downward to the attachment device from the roof of the moving body. When the attachment device is fixed to the roof of the moving body, the attachment device may be pulled downward and deformed with a fixed portion as a fulcrum. According to the attachment device according to this aspect, a linear distance between the fixing portion and any point in the attachment hole at which the tag is in contact with the attachment hole may be made smaller as compared with, for example, an aspect in which the attachment hole is located on the other end portion side with respect to the intermediate region of the second plate portion. That is, when a center of the fixing portion is used as the fulcrum, a linear distance to a force point may be reduced. Deformation of the attachment device may be prevented when the force is applied to the attachment device as compared with an aspect in which a region of the second plate portion that is close to the other end portion is the force point.

(3) In the above attachment device, the attachment hole may be formed over a first position that is an intermediate position in a longitudinal direction of the first plate portion and a second position that is an intermediate position in the longitudinal direction of the second plate portion.

Generally, when the impact is applied to the moving body, the airbag is inflated by being supplied with the gas. In the aspect in which the airbag is deployed downward from the roof of the moving body, the airbag is inflated downward from the roof of the moving body, so that the force is applied, by the airbag, downward to the attachment device from the roof of the moving body. When the attachment device is fixed to the roof of the moving body, the attachment device may be pulled downward and deformed with the fixed portion as a fulcrum.

According to the attachment device according to this aspect, a force is evenly applied to the second plate portion as compared with an aspect in which the attachment hole does not have the first position and the second position, which are the intermediate positions in the longitudinal direction of the first plate portion and the second plate portion. When the force is applied to the attachment device, a possibility of distortion of the second plate portion may be reduced.

(4) In the above attachment device, the fixing portion may be provided with a through hole through which a component passes, and the first plate portion may be fixed to the vehicle interior of the moving body via the component passing through the through hole.

According to the attachment device according to this aspect, the attachment device may be easily replaced as compared with, for example, an aspect in which the first plate portion is fixed to the moving body by an adhesive.

### BRIEF DESCRIPTION OF DRAWINGS

Exemplary embodiment(s) of the present invention will be described in detail based on the following figures, wherein:

FIG. 1 is a diagram illustrating an airbag device disposed in a vehicle according to an embodiment;

FIG. 2 is a diagram illustrating a part of the airbag device;

FIG. 3 is a diagram illustrating an attachment device as viewed from an angle different from that in FIG. 2;

FIG. 4 is a diagram illustrating the attachment device as viewed from an angle different from that in FIG. 3;

FIG. 5 is a diagram illustrating the attachment device as viewed from an angle different from that in FIG. 3;

FIG. 6 is a simplified diagram illustrating a state in which an airbag is attached to the attachment device;

FIG. 7 is a diagram illustrating an airbag device according to a comparative embodiment; and

FIG. 8 is a diagram illustrating an airbag of the airbag device according to the comparative embodiment being deployed.

### DESCRIPTION OF EMBODIMENTS

### A. Embodiment

### A1. Configuration

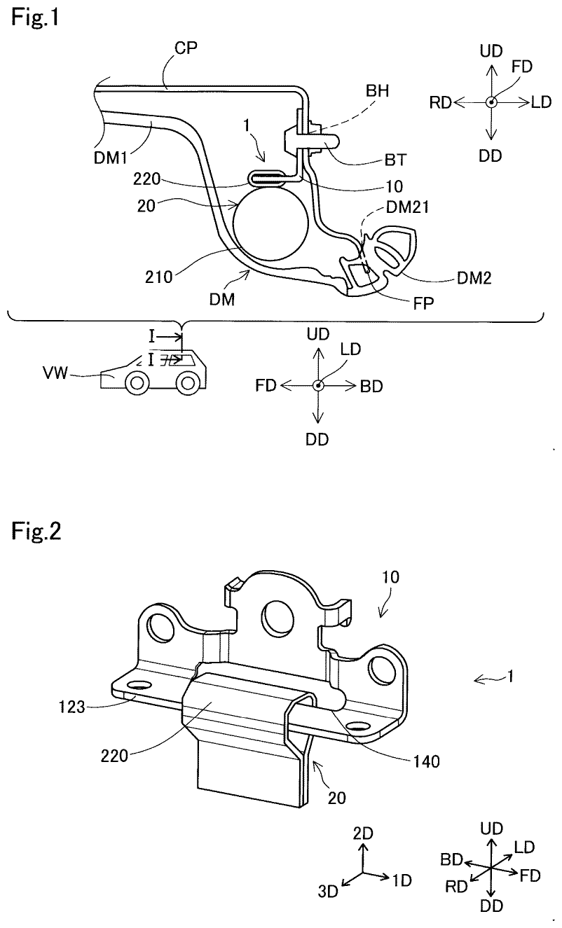

FIG. 1 is diagram illustrating an airbag device 1 disposed in a vehicle VW. FIG. 1 is a simplified cross-sectional view of a part of a vehicle interior of the vehicle VW. In FIG. 1, hatching is omitted. In FIG. 1, a forward direction FD indicates a front side in a traveling direction of the vehicle VW, and a backward direction BD indicates a back side in the traveling direction of the vehicle VW. An upward direction UD indicates an upper side in a height direction of the vehicle VW, and a downward direction DD indicates a lower side in the height direction of the vehicle VW. A direction perpendicular to the forward direction FD, the backward direction BD, the upward direction UD, and the downward direction DD is referred to as a left-right direction. A rightward direction RD is a direction toward the vehicle interior of the vehicle VW. A leftward direction LD is a direction toward a vehicle exterior of the vehicle VW. The forward direction FD and the backward direction BD may be collectively referred to as a front-back direction, the upward direction UD and the downward direction DD may be collectively referred to as an upper-lower direction, and the leftward direction LD and the rightward direction RD may be collectively referred to as the left-right direction.

FIG. 1 illustrates a part of a vehicle panel CP, a deformation member DM, and the airbag device 1, which will be described later, on a leftward direction LD side of the vehicle VW. On a rightward direction RD side of the vehicle VW, a configuration is provided that is symmetrical to a part of the vehicle panel CP, the deformation member DM, and the airbag device 1 in FIG. 1 with respect to a plane including the upper-lower direction and the front-back direction. Hereinafter, a part of the vehicle panel CP, the deformation member DM, and the airbag device 1 on the leftward direction LD side of the vehicle VW will be described.

The vehicle VW includes the vehicle panel CP and the deformation member DM. The vehicle panel CP is a part of a roof of the vehicle VW. The vehicle panel CP is a plate-shaped member. In the present embodiment, the vehicle panel CP includes twelve body holes BH and four fitting portions FP. The body hole BH is a hole for fixing an attachment device 10 (described later) of the airbag device 1 to the vehicle panel CP by passing components, which pass through a first through hole 112a to a third through hole 112c (described later), through respective body holes BH. In the present embodiment, three body holes BH are used to fix one attachment device 10. FIG. 1 illustrates only one body hole BH. In the present embodiment, the component is a bolt BT. The fitting portion FP is a portion that fits into a hole of an opening portion DM2 (described later). The fitting portion FP is formed at an end portion of the vehicle panel CP in the downward direction DD. A portion of the vehicle panel CP other than the fitting portions FP extends along the front-back direction of the vehicle VW. Although not illustrated, a side wall of the vehicle VW is disposed in the downward direction DD of the vehicle panel CP.

The deformation member DM is a member that is deformed when an airbag 20 (described later) of the airbag device 1 is deployed. The deformation member DM includes a roof portion DM1 and four opening portions DM2. The roof portion DM1 is a member that is pushed toward the downward direction DD of the vehicle VW by the airbag 20 when the airbag is deployed. The roof portion DM1 is a part of the roof of the vehicle VW. The roof portion DM1 is a plate-shaped member. The roof portion DM1 has a shape that extends from the upward direction UD to the downward direction DD of the vehicle VW and further extends toward the side wall of the vehicle VW. The roof portion DM1 further extends along the front-back direction of the vehicle VW. The roof portion DM1 is disposed in the downward direction DD with respect to the vehicle panel CP. The airbag 20 is accommodated in a space between the vehicle panel CP and the roof portion DM1. The roof portion DM1 is formed of an elastically deformable material. The roof portion DM1 pushed in the downward direction DD is elastically deformed in the downward direction DD.

The opening portion DM2 is a member that is engaged with the vehicle panel CP in a state in which the airbag 20 is not deployed. Specifically, the opening portion DM2 is engaged with the vehicle panel CP by providing a hole DM21 into which the fitting portion FP of the vehicle panel CP fits. The opening portion DM2 is connected to a lower end of the roof portion DM1. When the airbag 20 is deployed, the opening portion DM2 is pulled by the roof portion DM1 pushed in the downward direction DD. When the opening portion DM2 is pulled by the roof portion DM1, the fitting portion FP is disengaged from the holes DM21. Thus, an engagement between the opening portion DM2 and the vehicle panel CP is released. Although not illustrated in the drawings, when the engagement between the opening portion DM2 and the vehicle panel CP is released, a gap is generated between the opening portion DM2 and the vehicle panel CP. The deployment of the airbag 20 will be described later. In the present embodiment, the four opening portions DM2 are disposed along the front-back direction of the vehicle VW. Specifically, the four opening portions DM2 are disposed in the downward direction DD of respective four attachment devices 10 (described later). One of the opening portions DM2 is interlocked with the airbag 20 fixed to respective one of the attachment device 10.

FIG. 2 is a diagram illustrating a part of the airbag device 1. FIG. 2 illustrates a part of the airbag device 1. The airbag device 1 is mounted on the vehicle VW that is a moving body. When the vehicle VW collides or when a collision is predicted by an ECU of a vehicle (not illustrated), the airbag of the airbag device 1 is deployed to protect an occupant in the vehicle VW. The airbag device 1 according to the present embodiment is also called a curtain airbag. The airbag device 1 is fixed to the vehicle panel CP. In the present embodiment, the vehicle VW is provided with one airbag device 1 on each of end portions in the left-right direction. Hereinafter, the airbag device 1 on the leftward direction LD side of the vehicle VW will be described. The airbag device 1 includes the four attachment devices 10 and the airbag 20. FIG. 2 illustrates one attachment device 10 and a tab 220 (described later) of the airbag 20.

FIG. 2 illustrates the forward direction FD, the backward direction BD, the upward direction UD, the downward direction DD, the leftward direction LD, and the rightward direction RD in a state in which the airbag device 1 is mounted on the vehicle VW. Further, FIG. 2 illustrates a first direction 1D, a second direction 2D, and a third direction 3D. The first direction 1D is a direction along long sides of a first plate portion 110 and a second plate portion 120, which will be described later. The second direction 2D is a direction perpendicular to the first direction 1D and along a short side of the first plate portion 110. The third direction 3D is a direction perpendicular to the first direction 1D and the second direction 2D and along a short side of the second plate portion 120. In the present embodiment, the first direction 1D is parallel to the front-back direction, the second direction 2D is parallel to the upper-lower direction, and the third direction 3D is parallel to the left-right direction. The forward direction FD corresponds to a positive direction of the first direction 1D, the upward direction UD corresponds to a positive direction of the second direction 2D, and the rightward direction RD corresponds to a positive direction of the third direction 3D.

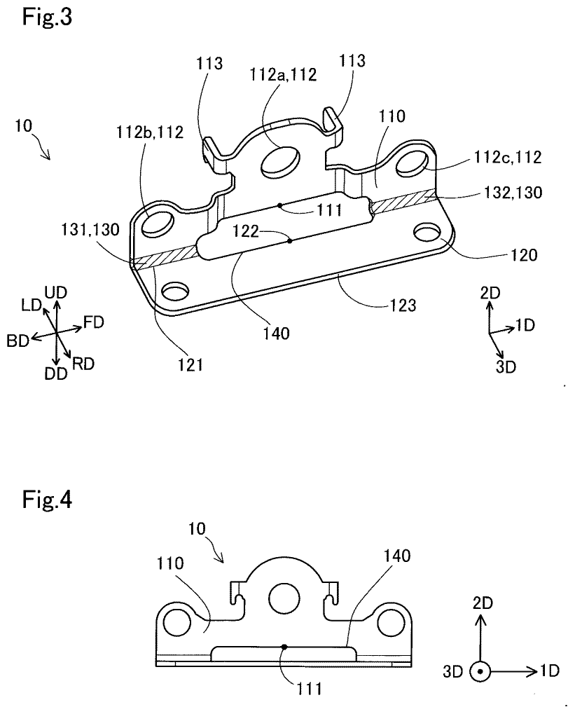

FIG. 3 is a diagram illustrating the attachment device 10 as viewed from an angle different from that in FIG. 2. In FIG. 3, the airbag 20 is omitted. FIG. 4 is a diagram illustrating the attachment device 10 as viewed from an angle different from that in FIG. 3. The attachment device 10 is a device for attaching the airbag 20 to the vehicle VW. Although not illustrated, in the present embodiment, the four attachment devices 10 are disposed along the front-back direction. The four attachment devices 10 fixes one airbag 20, so that the airbag 20 is disposed along the front-back direction of the vehicle VW. The four attachment devices 10 have a same configuration. Hereinafter, one attachment device 10 will be described.

As illustrated in FIG. 1, the attachment device 10 is fixed to the vehicle panel CP of the vehicle VW. In the present embodiment, the attachment device 10 is formed by pressing a metal plate. As illustrated in FIG. 3, the attachment device 10 includes the first plate portion 110, the second plate portion 120, and a bent portion 130. The first plate portion 110 is a plate-shaped member fixed to the vehicle interior of the vehicle VW. The first plate portion 110 is configured such that the long side extends along the first direction 1D and the short side extends along the second direction 2D. As illustrated in FIG. 4, an intermediate position of the first plate portion 110 in the first direction 1D that is a longitudinal direction is referred to as a first position 111. In the present embodiment, the first plate portion 110 is fixed to the vehicle panel CP of the vehicle VW. As illustrated in FIG. 3, the first plate portion 110 includes a fixing portion 112 and a locking portion 113.

The fixing portion 112 is a portion for fixing the first plate portion 110 to the vehicle VW. In the present embodiment, the fixing portion 112 is a portion to be fixed to the vehicle panel CP. In the present embodiment, the fixing portion 112 includes three through holes through which the bolts BT serving as the components pass. The three through holes are referred to as the first through hole 112a, the second through hole 112b, and the third through hole 112c, respectively. Although not illustrated, the bolts BT are passed through the above three body holes BH of the vehicle panel CP, the first through hole 112a, the second through hole 112b, and the third through hole 112c in a state in which each of the three body holes BH is overlapped with respective one of the first through hole 112a, the second through hole 112b, and the third through hole 112c in the third direction 3D. The first plate portion 110 is fixed to the vehicle panel CP via the bolts BT that are passed through the first through hole 112a, the second through hole 112b, and the third through hole 112c. The attachment device 10 may be replaced more easily as compared with, for example, an aspect in which the first plate portion 110 is fixed to the vehicle VW by an adhesive. The first through hole 112a is formed at an intermediate position of the first plate portion 110 in the longitudinal direction. The second through hole 112b and the third through hole 112c are formed at respective end portions of the first plate portion 110 in the longitudinal direction.

The locking portion 113 is a portion that is locked to a locked portion (not illustrated) of the vehicle panel CP. In a state where the locking portion 113 is locked to the locked portion, the bolts BT are passed through the first through hole 112a to the third through hole 112c. The locking portion 113 is a portion protruding toward a negative direction side in the third direction 3D. The locking portion 113 is formed around an end portion of the first plate portion 110 on a positive direction side of the second direction 2D. When the locking portion 113 is locked, the body holes BH are overlapped with the first through hole 112a to the third through hole 112c in the third direction 3D. Therefore, the locking portion 113 functions as a positioning unit when the attachment device 10 is fixed to the vehicle VW.

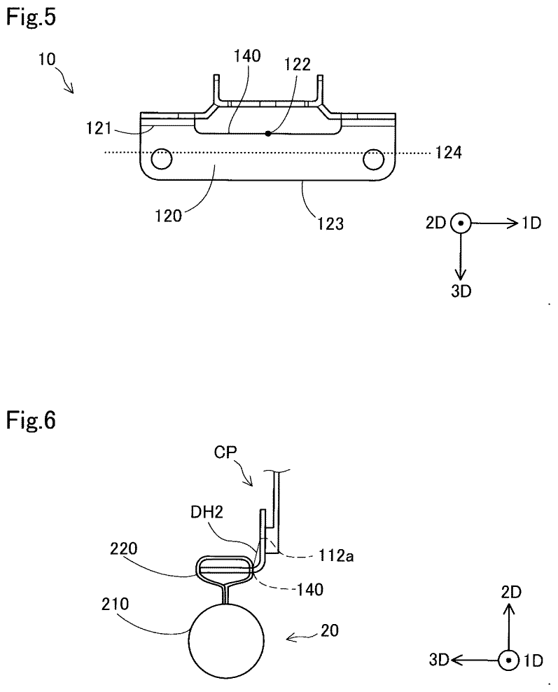

FIG. 5 is a diagram illustrating the attachment device 10 as viewed from an angle different from that in FIG. 3. The second plate portion 120 is a plate-shaped member to which the tab 220 (described later) of the airbag 20 is fixed. As illustrated in FIG. 3, one end portion 121 of the second plate portion 120 is connected to the bent portion 130. A part of the one end portion 121 of the second plate portion 120 is connected to the first plate portion 110 via the bent portion 130. Regarding the second plate portion 120, the long side is aligned along the first direction 1D, and the short side is aligned along the third direction 3D. As described above, since the short side of the first plate portion 110 is aligned along the second direction 2D, the second plate portion 120 is arranged in a direction different from that of the first plate portion 110. In the present embodiment, the first plate portion 110 is arranged in a direction along the upper-lower direction of the vehicle VW, whereas the second plate portion 120 is arranged in a direction along the left-right direction of the vehicle VW. A dimension in a direction along the first plate portion 110 may be made smaller as compared with an aspect in which the first plate portion 110 and the second plate portion 120 are arranged to form a same plane. Therefore, the airbag 20 may be attached to a space in a vicinity of a lateral end portion of the roof of the vehicle VW. As illustrated in FIG. 5, an intermediate position of the second plate portion 120 in the first direction 1D that is the longitudinal direction is referred to as a second position 122.

The bent portion 130 illustrated in FIG. 3 is a portion that connects the first plate portion 110 and the second plate portion 120. In FIG. 3, in order to facilitate understanding, the bent portion 130 is hatched. The bent portion 130 includes a first bent portion 131 and a second bent portion 132. The first bent portion 131 is connected to a part of a long side end portion of the first plate portion 110 and a part of a long side end portion of the second plate portion 120. The first bent portion 131 is bent when viewed along the first direction 1D. The second bent portion 132 is connected to a part of the other portion of the long side end portion of the first plate portion 110 and a part of the other portion of the long side end portion of the second plate portion 120. The second bent portion 132 is bent when viewed along the first direction 1D. The second bent portion 132 is separated from the first bent portion 131 in the first direction 1D.

As illustrated in FIG. 3, the attachment device 10 has an attachment hole 140. The attachment hole 140 is a hole through which the tab 220 of the airbag 20 passes. The attachment hole 140 is formed by connecting the first plate portion 110, the second plate portion 120, and the bent portion 130. A shape of the attachment hole 140 is defined by a part of the long side of the first plate portion 110, a part of the long side of the second plate portion 120, and the bent portion 130. In the present embodiment, the shape of the attachment hole 140 is defined by portions, which are not connected to the bent portion 130, of the long side end portions of the first plate portion 110 and the second plate portion 120, and short side end portions of the bent portion 130. A part of the attachment hole 140 is located in the first plate portion 110. The other part of the attachment hole 140 is located in the second plate portion 120. As illustrated in FIG. 5, in the present embodiment, the other part of the attachment hole 140 is located on one end portion 121 side with respect to an intermediate region 124 that is an intermediate region in the third direction 3D, which is a direction from the one end portion 121 toward the other end portion 123 of the second plate portion 120. In the present embodiment, the attachment hole 140 has the first position 111 of the first plate portion 110 (see FIG. 4). In addition, in the present embodiment, the attachment hole 140 has the second position 122 of the second plate portion 120 (see FIG. 5). The attachment hole 140 has a shape extending in the first direction 1D.

The airbag 20 illustrated in FIG. 1 is a device that is deployed to protect the occupant when the vehicle VW is subjected to an impact or when it is predicted that the vehicle VW is subjected to the impact. The airbag 20 is deployed, from the roof of the vehicle VW, downward in the vehicle VW along the side wall of the vehicle interior of the vehicle VW. In the present embodiment, the airbag 20 is deployed, from the vehicle panel CP constituting the roof of the vehicle VW, in the downward direction DD along the side wall of the vehicle interior of the vehicle VW. The airbag 20 includes an airbag body 210 and four tabs 220. The airbag body 210 is inflated by being supplied with a gas when the vehicle VW is subjected to the impact or when it is predicted that the vehicle VW is subjected to the impact. The airbag body 210 is folded as illustrated in FIG. 1 in a state in which no gas is supplied. When the gas is supplied to the airbag body 210, the inflated airbag body 210 pushes the roof portion DM1 in the downward direction DD. When the opening portion DM2 connected to the roof portion DM1 is pulled by the roof portion DM1 and thus the engagement between the opening portion DM2 and the vehicle panel CP is released, the airbag body 210 is deployed in the downward direction DD. As described above, in the present embodiment, one airbag body 210 is attached to the four attachment devices 10 via the four tabs 220. When the airbag body 210 is deployed, the engagement between the four opening portions DM2 of the deformation member DM and the vehicle panel CP is released. Accordingly, the airbag body 210 is completely deployed. The airbag body 210 is formed by sewing a plurality of pieces of cloth. The airbag 20 has a bag-shaped shape.

FIG. 6 is a simplified diagram illustrating a state in which the airbag 20 is attached to the attachment device 10. Shapes of the vehicle panel CP and the airbag device 1 illustrated in FIG. 6 are simplified for explanation. The tab 220 is a portion for attaching the airbag body 210 to the attachment device 10. One of the tabs 220 is attached to respective one of the attachment devices 10. The four tabs 220 have a same configuration. Hereinafter, one tab 220 will be described. As illustrated in FIG. 2, the tab 220 is fixed to the attachment hole 140 by passing through the attachment hole 140. In the present embodiment, the tab 220 is made of cloth. The tab 220 is fixed to the attachment hole 140 by sewing end portions of the tab 220 passed through the attachment hole 140. Although not illustrated in FIG. 2, the airbag body 210 is sewn to the end portions of the tab 220. The tab 220 is arranged from the attachment hole 140 to the other end portion 123 of the second plate portion 120.

### A2. Comparison With Comparative Embodiment

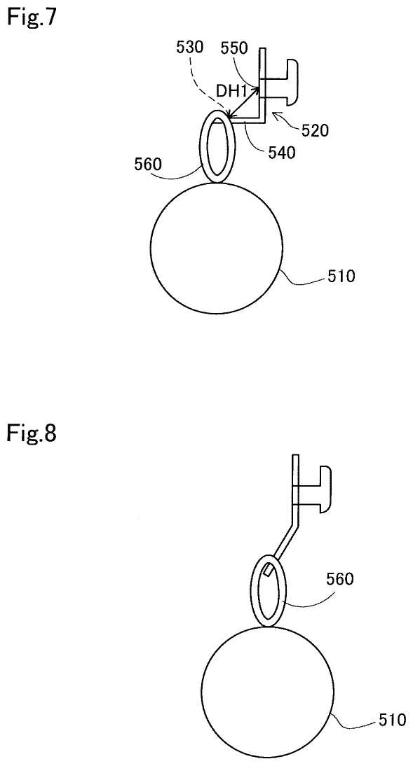

FIG. 7 is a diagram illustrating an airbag device 50 according to a comparative embodiment. FIG. 8 is a diagram illustrating an airbag 510 of the airbag device 50 according to the comparative embodiment being deployed. A structure of an attachment device 520 of the airbag device 50 according to the comparative embodiment is different from a structure of the attachment device 10 according to the present embodiment. In the comparative embodiment, an attachment hole 530 is provided only in a second plate portion 540. In the comparative embodiment, the attachment hole 530 has a region located on the other end portion side with respect to an intermediate region of the second plate portion 540.

Generally, when the impact is applied to the vehicle VW, the airbag 20 is inflated by being supplied with the gas. In an aspect in which the airbag 20 is deployed downward from the roof of the vehicle VW, the airbag 20 is inflated downward from the roof of the vehicle VW, so that a force is applied, by the airbag 20, downward to the attachment device 10 from the roof of the vehicle VW. When the attachment device 10 is fixed to the roof of the vehicle VW, the attachment device 10 may be pulled downward and deformed with a fixed portion as a fulcrum (see FIG. 8). In the comparative embodiment, a distance between a center of a first through hole 550 of the attachment device 10 and a comparison point PC in the attachment hole 530 is DH1 (see FIG. 7). The comparison point PC is any point at which the tab 560 of the airbag 510 is in contact with the attachment hole 530. In the attachment device 10 according to the present embodiment, as described above, the other part of the attachment hole 140 is located on the one end portion 121 side with respect to the intermediate region 124 of the second plate portion 120 (see FIG. 5). A distance between a center of the first through hole 112a of the attachment device and any point AP in the attachment hole 140 is DH2 (see FIG. 6). The any point AP is any point at which the tab 220 of the airbag 20 is in contact with the attachment hole 140. The distance DH2 is smaller than the distance DH1. The comparison point PC illustrated in FIG. 7 is an intermediate region of a long side end portion of the second plate portion 540 according to the comparative embodiment. The any point AP illustrated in FIG. 6 is the second position 122 that is the intermediate position of the long side end portion of the second plate portion 120.

In the attachment device 10 according to the present embodiment, a linear distance between the first through hole 112a, which is the fixing portion 112, and any point in the attachment hole 140, at which the tag is in contact with the attachment hole 140, can be made smaller as compared with an aspect in which the attachment hole 140 is located on the other end portion 123 side with respect to the intermediate region of the second plate portion 120 (see the distance DH1 in FIG. 7 and the distance DH2 in FIG. 6). In addition, a linear distance between the second through hole 112b or the third through hole 112c and any point in the attachment hole 140, at which the tag is in contact with the attachment hole 140, may also be made smaller than that in the comparative embodiment. That is, when a center of the fixing portion 112 is used as the fulcrum, a linear distance to a force point may be reduced. A magnitude of a force required for the second plate portion 120 to deform in the downward direction DD is greater when a force toward the downward direction DD is applied to the attachment device 10 by the airbag 20 as compared with an aspect in which a region of the second plate portion 120 that is close to the other end portion 123 is a force point. Deformation of the attachment device 10 may be prevented as compared with an aspect in which the region of the second plate portion 120 that is close to the other end portion 123 is the force point.

Further, in the present embodiment, a force is evenly applied to the second plate portion 120 by the airbag 20 when the airbag 20 is deployed as compared with an aspect in which the attachment hole 140 does not have the first position 111 and the second position 122, which are the intermediate positions in the longitudinal direction of the first plate portion 110 and the second plate portion 120. When the force is applied to the attachment device 10, a possibility of distortion of the second plate portion 120 may be reduced.

### B. Other Embodiments

### B1. Other Embodiment 1

(1) In the above-described embodiment, the attachment device 10 includes the bent portion 130. An attachment device may not include a bent portion, and a first plate portion and a second plate portion may be directly connected to each other, for example.

(2) In the above-described embodiment, the attachment device 10 is mounted on the vehicle VW. An airbag device may be mounted on a moving body other than the vehicle. For example, the airbag device may be mounted on a moving body such as a flying machine or a ship.

(3) In the above-described embodiment, the front-back direction is parallel to the first direction 1D, the upper-lower direction is parallel to the second direction 2D, and the left-right direction is parallel to the third direction 3D. For example, the front-back direction may not be completely parallel to the first direction, the upper-lower direction may not be completely parallel to the second direction, and the left-right direction may not be completely parallel to the third direction.

(4) In the above-described embodiment, the tab 220 is made of cloth. For example, a tab may be made of metal. In this aspect, for example, the tab may be formed with a hole through which a bolt passes, and an airbag body and the tab may be connected via the bolt.

(5) In the above-described embodiment, the vehicle VW is provided with one airbag device 1 on each of left and right sides. For example, a vehicle may be provided with one airbag device on one of left and right sides.

(6) In the above-described embodiment, in the vehicle VW, the four attachment devices 10 are mounted on each of the left and right sides, and one tab 220 is attached to each of the four attachment devices 10. For example, one attachment device may be mounted on each of the left and right sides of the vehicle. In this aspect, a deformation member may include one opening portion on each of the left and right sides.

### B2. Other Embodiment 2

(1) In the above-described embodiment, the first plate portion 110 includes the fixing portion 112 for fixing the first plate portion 110 to the moving body. For example, in an aspect in which a first plate portion is fixed to the moving body by an adhesive, the first plate portion may not include a fixing portion.

(2) In the above-described embodiment, the other part of the attachment hole 140 is located on the one end portion 121 side with respect to the intermediate region 124 of the second plate portion 120. For example, the other part of the attachment hole may be located on the other end portion side with respect to an intermediate region of a second plate portion.

### B3. Other Embodiment 3

(1) In the above-described embodiment, the attachment hole 140 has the first position 111 and the second position 122. For example, an attachment hole may not have a first position and a second position. For example, the attachment hole may have the first position and not have the second position. In addition, for example, the attachment hole may have the second position and the first position. In this aspect, a force is also evenly applied to a second plate portion as compared with an embodiment in which the attachment hole does not have the second position. When a force is applied to an attachment device, a possibility of distortion of the second plate portion may be reduced.

(2) In the above-described embodiment, the attachment hole 140 has a shape extending in the first direction 1D. For example, the attachment hole may have a substantially circular shape.

### B4. Other Embodiment 4

(1) In the above-described embodiment, the first plate portion 110 has the first through hole 112a to the third through hole 112c. An attachment device is more firmly fixed to a vehicle panel by fixing a first plate portion to the vehicle panel via three through holes as compared with, for example, an aspect in which a first plate portion has one through hole. For example, a fixing portion may include only a first through hole. In this embodiment, the attachment device may be easily replaced as compared with an aspect in which the fixing portion is fixed to a moving body by an adhesive.

(2) In the above-described embodiment, the first through hole 112a, the second through hole 112b, and the third through hole 112c are holes through which the bolts BT serving as the components pass. For example, through holes may be holes into which convex portions formed on a vehicle fit.

(3) The fixing portion may be, for example, a convex portion formed in the first plate portion, and the attachment device may be fixed to the vehicle by fitting the convex portion into a hole formed on the vehicle. In this embodiment, the attachment device may be easily replaced as compared with the aspect in which the fixing portion is fixed to the moving body by the adhesive.

The present disclosure is not limited to the above embodiments, and may be implemented by various configurations without departing from the gist of the present disclosure. For example, technical features in the embodiments corresponding to technical features in aspects described in the summary of the invention may be replaced or combined as appropriate to solve a part or all of the above-described problems or to achieve a part or all of the above-described effects. The technical features may be appropriately deleted unless being described as necessary in the present specification.

What is claimed is:

1. An attachment device for attaching, to a moving body, an airbag configured to be deployed downward in the moving body from a roof of the moving body along a side wall of a vehicle interior of the moving body, the attachment device comprising:
a first plate portion that is a plate-shaped member configured to be fixed to the vehicle interior of the moving body; and
a second plate portion that is a plate-shaped member to which a tab of the airbag is fixed, wherein
the first plate portion and the second plate portion are arranged such that the first plate portion and the second plate portion face to different directions from each other, and
an attachment hole through which the tab of the airbag passes is formed in the attachment device, a part of the attachment hole being located in the first plate portion, and the other part of the attachment hole being located in the second plate portion.

2. The attachment device according to claim 1, wherein
the first plate portion includes a fixing portion configured to fix the first plate portion to the vehicle interior of the moving body,
a part of one end portion of the second plate is connected to the first plate portion,
the other part of the attachment hole is located at a side of the one end portion with respect to an intermediate region in a direction from the one end portion toward the other end portion of the second plate portion, and
the tab is arranged from the attachment hole to the other end portion of the second plate portion.

3. The attachment device according to claim 2, wherein
the attachment hole is formed over a first position that is an intermediate position in a longitudinal direction of the first plate portion and a second position that is an intermediate position in the longitudinal direction of the second plate portion.

4. The attachment device according to claim 2, wherein
the fixing portion is provided with a through hole through which a component passes, and the first plate portion is fixed to the vehicle interior of the moving body via the component passing through the through hole.
